(19) United States
(12) Patent Application Publication
(10) Pub. No.: US 2010/0290659 A1
(43) Pub. Date: Nov. 18, 2010

(54) LOUDSPEAKER ASSEMBLY AND ELECTRONIC EQUIPMENT

(75) Inventors: Takahisa Tagami, Kanagawa (JP); Emiko Ikeda, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: SONY CORPORATION, Tokyo (JP)

(21) Appl. No.: 12/764,385

(22) Filed: Apr. 21, 2010

(30) Foreign Application Priority Data
May 12, 2009 (JP) 2009-115144

(51) Int. Cl. H04R 1/20

(52) U.S. Cl. 381/352

(57) ABSTRACT

A loudspeaker assembly includes a loudspeaker located at the position of one of the focuses of a reflector, whose over-internal wall section constitutes a part of an ellipse, in such a manner that the sounds-releasing surface of the loudspeaker is oriented to be opposite to the internal wall surface of the reflector.

### BACKGROUND OF THE INVENTION

1. Field of the Invention

The present invention relates to a loudspeaker assembly having a reflector that reflects released sounds, and an electronic equipment including the loudspeaker assembly.

2. Description of the Related Art

A loudspeaker assembly designed so that sounds released from a loudspeaker can be propagated obliquely backward, and reflected from a reflecting plate, which is attached to the back plate of a loudspeaker cabinet, in order to radiate the reflected sounds toward a listener has been disclosed in, for example, JP-A-2003-23692 (patent document 1).

According to the loudspeaker assembly described in the patent document 1, the position of a sound source is separated from a user in order to minimize an oppressive feeling caused by a sound pressure and provide a sense of depth. A sound field having a frequency characteristic thereof extended to a high acoustic frequency band can be reproduced.

### SUMMARY OF THE INVENTION

Various electronic equipments each having a display screen, such as, a television set, a personal computer, a portable cellular phone, and a game machine have difficulty in preserving a position, at which a loudspeaker is disposed, along with the tendency toward adoption of a larger display screen.

For example, as far as the television set is concerned, the loudspeaker is disposed on the rear side of the television set (behind the display screen). In some types of television sets, sounds released from the loudspeaker are routed to a direction below or by the side of the display screen or routed to a direction in front of the display screen through a gap.

However, when the loudspeaker is disposed behind the display screen, sounds released from the loudspeaker are reflected from various entities or affected by various obstacles. The sounds may be deteriorated until they reach the listener's ears. Therefore, a satisfactory sound field may not be reproduced in some cases.

For example, when the loudspeaker is disposed on the rear side of the television set, if a reflecting plate is positioned in advance as it is according to the technology described in the patent document 1, the released sounds can be reflected from the reflecting plate on the rear side of the television set and delivered to a listener.

However, it is hard to control the sounds reflected from the reflecting plate exactly in a predicted manner. Presumably, the frequency characteristic or directivity of the sounds may be changed with respect to that of original sounds.

When the position at which the loudspeaker is disposed is discussed in terms of the superiority in the design of an electronic equipment, the superiority in the design of the electronic equipment is requested to be upgraded by arranging the loudspeaker at a position at which a user is unconscious of the presence of the loudspeaker.

The present invention addresses the foregoing points. Even when a loudspeaker is disposed with the sounds-releasing surface thereof oriented to a direction opposite to a listener, it is desirable to realize the same acoustic characteristics as the acoustic characteristics provided when the sounds-releasing surface is oriented to the listener.

According to an embodiment of the present invention, there is provided a loudspeaker assembly in which a loudspeaker is located at the position of one of the focuses of a reflector, whose over-internal wall section constitutes a part of an ellipse, in such a manner that the sounds-releasing surface thereof is oriented to be opposite to the internal wall surface of the reflector.

According to the loudspeaker assembly of the embodiment, sounds are released from the loudspeaker, which is located at the position of one of the focuses of the reflector whose over-internal wall section constitutes a part of an ellipse, in the direction of the internal wall surface of the reflector.

The sounds released from the loudspeaker are reflected from the internal wall surface of the reflector whose over-internal wall section constitutes a part of an ellipse, and concentrated on the other focus over the internal wall surface. Eventually, a virtual sound source (virtual sound image) is formed at the position of the other focus.

Therefore, sounds released from the loudspeaker that releases sounds in the direction of the internal wall surface of the reflector are reflected from the internal wall surface of the reflector, and radiated from the other focus in a direction opposite to the sounds-releasing direction of the loudspeaker.

In this case, the virtual sound source that ensures the same acoustic characteristics (frequency characteristic, phase, and directivity) as the acoustic characteristics of sounds released from the loudspeaker is formed at the position of the other focus with the sounds-releasing direction thereof made opposite to the sounds-releasing direction of the loudspeaker.

Therefore, even when the loudspeaker is disposed with the sounds-releasing surface thereof oriented in a direction opposite to a listener, the acoustic characteristics of sounds reproduced and heard by a listener are squared with the acoustic characteristics ensured when the sounds-releasing surface of the loudspeaker is oriented to the listener.

According to the embodiment of the present invention, even when the loudspeaker is disposed with the sounds-releasing surface thereof oriented in a direction opposite to a listener, the same acoustic characteristics as the acoustic characteristics ensured when the sounds-releasing surface is oriented to the listener can be realized.

### BRIEF DESCRIPTION OF THE DRAWINGS

FIGS. 1A and 1B are diagrams for use in explaining a loudspeaker assembly in accordance with a first embodiment of the present invention;

FIG. 2 is a diagram for use in explaining an equation expressing an ellipse and focus coordinates;

FIGS. 3A and 3B are diagrams for use in explaining the nature of an ellipse;

FIG. 4 is a diagram showing a section of the loudspeaker assembly shown in FIGS. 1A and 1B and cut along the major axis of a semi-ellipsoidal body 1;

FIG. 5 is a diagram for use in explaining a loudspeaker 2a shown in FIGS. 1A and 1B and FIG. 2;

FIGS. 6A and 6B are diagrams for use in explaining a case where the sounds-releasing surface of the loudspeaker 2a is oriented to a listener in comparison with a case where the loudspeaker assembly in accordance with the first embodiment is employed;

FIGS. 7A to 7D are diagrams for use in explaining variants of the loudspeaker assembly in accordance with the first embodiment;

FIGS. 8A and 8B are diagrams for use in explaining a loudspeaker assembly in accordance with a second embodiment of the present invention;

FIG. 9 is a diagram showing a section of the loudspeaker assembly shown in FIG. 8B and cut at a position indicated with an arrow a;

FIG. 10 is a diagram for use in explaining an example in which light emitting diodes (LEDs) are disposed on a semi-ellipsoidal column 11;

FIGS. 11A to 11D are diagrams for use in explaining a case where the loudspeaker assembly in accordance with the first or second embodiment is incorporated in a notebook personal computer 20;

FIGS. 12A to 12F are diagrams for use in explaining a case where the loudspeaker assembly in accordance with the first embodiment is incorporated in a television set;

FIGS. 13A to 13F are diagrams for use in explaining a case where the loudspeaker assembly in accordance with the second embodiment is incorporated in a television set;

FIGS. 14A to 14D are diagrams for use in explaining a case where the semi-ellipsoidal column 11 is made movable with respect to an electronic equipment (for example, a television set 30);

FIG. 15 is a diagram for use in explaining an example of the constitution of a loudspeaker assembly employing both a loudspeaker of a point sound source and loudspeakers of linear sound sources;

FIG. 16 is a diagram for use in explaining an example of the constitution of a loudspeaker assembly employing both the loudspeaker of a point sound source and the loudspeakers of linear sound sources; and

FIGS. 17A to 17D are diagrams for use in explaining a case where the loudspeaker assembly in accordance with the first embodiment is incorporated in a portable cellular phone.

### DESCRIPTION OF THE PREFERRED EMBODIMENTS

Referring to the drawings, a loudspeaker assembly in which the present invention is implemented and an electronic equipment employing the loudspeaker assembly will be described below.

### [Outline of the Invention]

An embodiment of the present invention relates to a loudspeaker assembly constituted by noting the fact that an ellipse has two focuses on the major axis thereof. The loudspeaker assembly includes a reflector which reflects sounds released from a loudspeaker and whose over-internal wall section constitutes a part of an ellipse.

The loudspeaker is located at the position of one of the focuses of the reflector, whose over-internal wall section constitutes a part of an ellipse, so that that the sounds-releasing surface thereof can be opposed to the internal wall of the reflector. In other words, the loudspeaker is located at the position of one of the focuses of the reflector in order to release sounds toward the internal wall of the reflector.

Accordingly, sounds released from the loudspeaker are reflected from the internal wall surface of the reflector, propagated to be concentrated on the position of the other focus, and further propagated to recede from the internal wall surface of the reflector. Namely, a virtual sound source is formed at the position of the other focus of the reflector whose over-internal wall section constitutes a part of an ellipse.

In this case, sounds radiated from the virtual sound source formed at the position of the other focus of the reflector exhibit the same acoustic characteristics (frequency characteristic, phase, and directivity) as the sounds released from the loudspeaker located at the position of one of the focuses do. Therefore, a listener who lies in a direction opposite to the sounds-releasing direction of the loudspeaker can hear the sounds exhibiting the same acoustic characteristics as the sounds released from the loudspeaker do.

Hereinafter, the loudspeaker assembly in which the present invention is implemented will be concretely described below by discriminating an example in which a loudspeaker serving as a point sound source is employed from an example in which a loudspeaker serving as a linear sound source is employed. Thereafter, concrete examples of application of the loudspeaker assembly to electronic equipments will be described.

### First Embodiment

### Example in which a Loudspeaker of a Point Sound Source is Employed

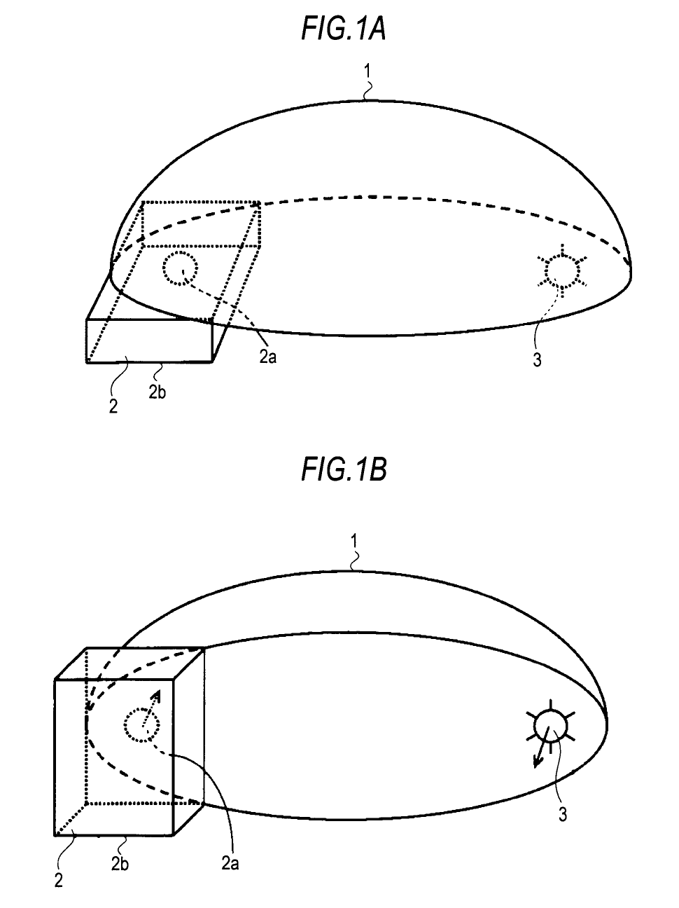

FIGS. 1A and 1B are diagrams for use in explaining a loudspeaker assembly in accordance with the first embodiment. The loudspeaker assembly in accordance with the first embodiment broadly includes a semi-ellipsoidal body 1 serving as a sounds reflector and a loudspeaker unit 2.

FIG. 1A is a diagram in which the loudspeaker assembly is seen from the front surface (curved surface) side of the semi-ellipsoidal body 1, while FIG. 1B is a diagram in which the loudspeaker assembly is seen from the opening side of the semi-ellipsoidal body 1. The loudspeaker assembly in accordance with the first embodiment which will be detailed later is an example in which a loudspeaker serving as a point sound source is employed.

As shown in FIGS. 1A and 1B, the semi-ellipsoidal body 1 is a solid formed by bisecting an ellipsoid obtained by rotating an ellipse about its major axis. More particularly, the semi-ellipsoidal body 1 is a solid formed by bisecting an ellipsoid like a football along the center axis, and is hollowed.

The semi-ellipsoidal body 1 is made of a material capable of reflecting sound waves, for example, a metal, a resin, a synthetic resin, wood, rubber, or glass. The semi-ellipsoidal body 1 has a thickness of, for example, about several millimeters.

The loudspeaker unit 2 includes a loudspeaker 2a and a casing (loudspeaker casing) 2b in which the loudspeaker 2a is stored. The upper surface of the casing 2b has an opening. The loudspeaker 2a is mounted in the casing 2b in such a manner that a diaphragm (cone) of the loudspeaker 2a is exposed to outside through the opening.

As shown in FIGS. 1A and 1B, the loudspeaker unit 2 has the diaphragm of the loudspeaker 2a thereof opposed to the internal wall surface of the semi-ellipsoidal body 1. The loudspeaker unit 2 is fixed to the semi-ellipsoidal body 1 so that the center of the diaphragm of the loudspeaker 2a can coincide with the position of one of the focuses of the semi-ellipsoidal body 1.

As mentioned above, a graphic of an ellipse has two focuses. The ellipse has the nature that sounds released from the position of one of the focuses are reflected from the circumference of the ellipse and concentrated on the position of the other focus.

Therefore, in FIGS. 1A and 1B, sounds released from the loudspeaker 2a are reflected from the internal wall surface of the semi-ellipsoidal body 1 and concentrated on the other focus. Eventually, a virtual sound source is formed at the position of the other focus as shown as the virtual sound source 3 in FIGS. 1A and 1B.

Therefore, in the case of the loudspeaker assembly in accordance with the first embodiment shown in FIGS. 1A and 1B, sounds released from the loudspeaker 2a can be heard as if the sounds were sounds released from the virtual sound source 3.

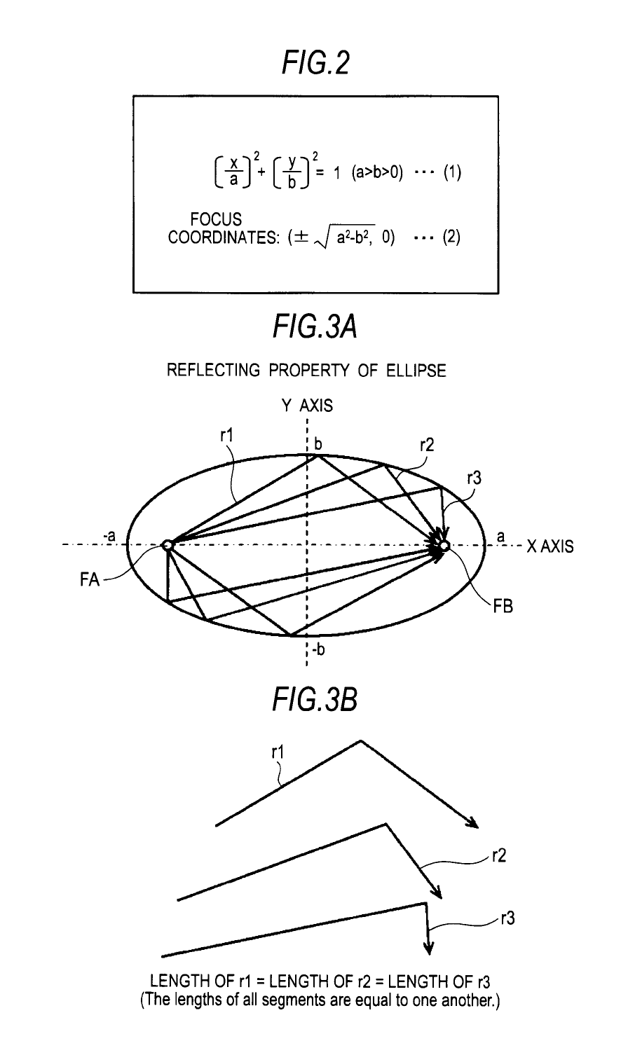

FIG. 2 is a diagram for use in explaining an equation expressing an ellipse and focus coordinates of the ellipse. FIGS. 3A and 3B are diagrams for use in explaining the nature of an ellipse.

An equation expressing a regular ellipse (a standard shape of an ellipse) is, as presented as an equation (1) in FIG. 2, a quadratic equation. The focuses of the ellipse are, as expressed by an equation (2) in FIG. 2, present on positive and negative sides respectively.

Therefore, the ellipse has, as shown in FIG. 3A, a focus FA on the negative side of the x axis and a focus FB on the positive side thereof. The ellipse has a property that when sounds released from the focus FA are, as indicated with broken lines in FIG. 3A, reflected from the circumference of the ellipse, the sounds are all concentrated on the other focus FB.

As shown in FIGS. 3A and 3B, distances by which sounds released in various directions from the focus FA propagate until they reach the focus FB after being reflected from the circumference of an ellipse are equal to one another. Namely, as shown in FIGS. 3A and 3B, the lengths of broken lines r1, r2, and r3 representing some of paths along which the sounds are reflected are equal to one another.

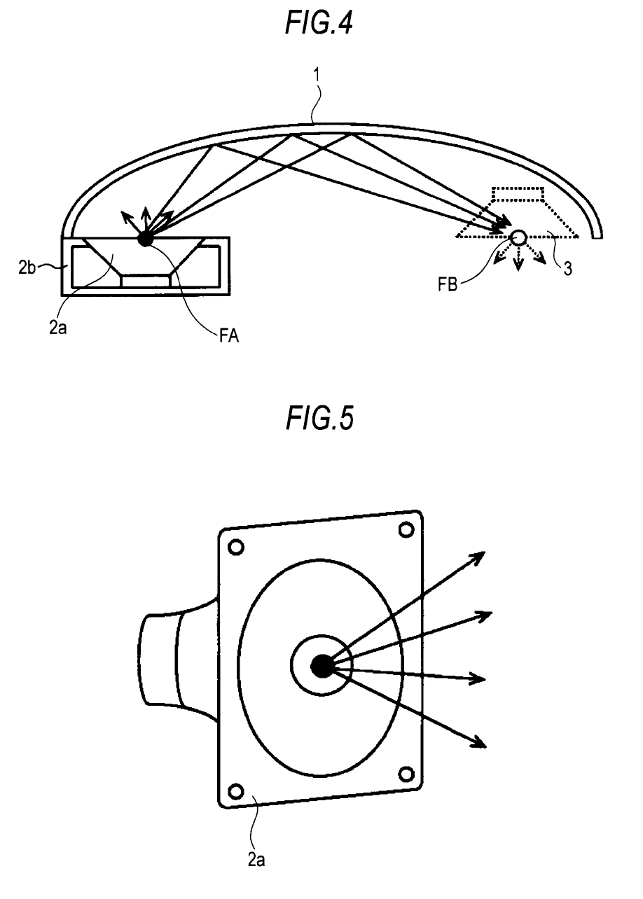

FIG. 4 is a diagram for use in explaining the loudspeaker assembly in accordance with the first embodiment to which the aforesaid nature of an ellipse is applied. FIG. 4 shows a section of the loudspeaker assembly shown in FIGS. 1A and 1B and cut along the major axis of the semi-ellipsoidal body 1. FIG. 5 is a diagram for use in explaining the loudspeaker 2a employed in the loudspeaker assembly in accordance with the first embodiment.

As shown in FIG. 5, the loudspeaker 2a is a loudspeaker having a relatively small aperture. Specifically, the area of a portion of the loudspeaker 2a that outputs sounds (diaphragm (cone)) is small for a wavelength, and the loudspeaker 2a serves as a point sound source. Sounds released from the point sound source are characteristic of spherical expansion.

As shown in FIG. 4, the focus FA and focus FB are the two focuses of the semi-ellipsoidal body 1. Therefore, as mentioned above, the loudspeaker 2a is disposed so that the diaphragm thereof can be opposed to the internal wall surface of the semi-ellipsoidal body 1 and the center of the diaphragm can coincide with the focus FA.

In this case, sounds released from the loudspeaker 2a are, as indicated with the broken lines in FIG. 4, reflected from the internal wall surface of the semi-ellipsoidal body 1 and then concentrated on the focus FB that is the other focus. The sounds are, as indicated with arrows drawn with dot lines in FIG. 4, radiated from the focus FB to outside the semi-ellipsoidal body 1. Namely, the direction in which the sounds are released from the loudspeaker 2a is turned.

In this case, as described in conjunction with FIGS. 3A and 3B and FIG. 4, from whatever positions on the internal wall surface of the semi-ellipsoidal body 1 sounds released from the loudspeaker 2a located at the position of the focus FA are reflected, the distances by which the sounds propagate until they reach the other focus FB are equal to one another.

Therefore, sounds released from the loudspeaker 2a are concentrated on the other focus FB without production of a phase difference. Thereafter, the sounds are propagated to outside the semi-ellipsoidal body 1. When the semi-ellipsoidal body 1 is made of a material exhibiting high reflecting efficiency, the frequency characteristic of the sounds released from the loudspeaker 2a will remain unchanged.

Specifically, sounds released from the loudspeaker 2a, and sounds reflected from the internal wall surface of the semi-ellipsoidal body 1, concentrated on the focus FB, and then radiated (sounds radiated from the virtual sound source 3) are identical to each other in terms of the frequency characteristic, phase, and directivity. In other words, the virtual sound source 3 that outputs sounds having the same frequency characteristic, phase, and directivity as the actual loudspeaker 2a does is formed.

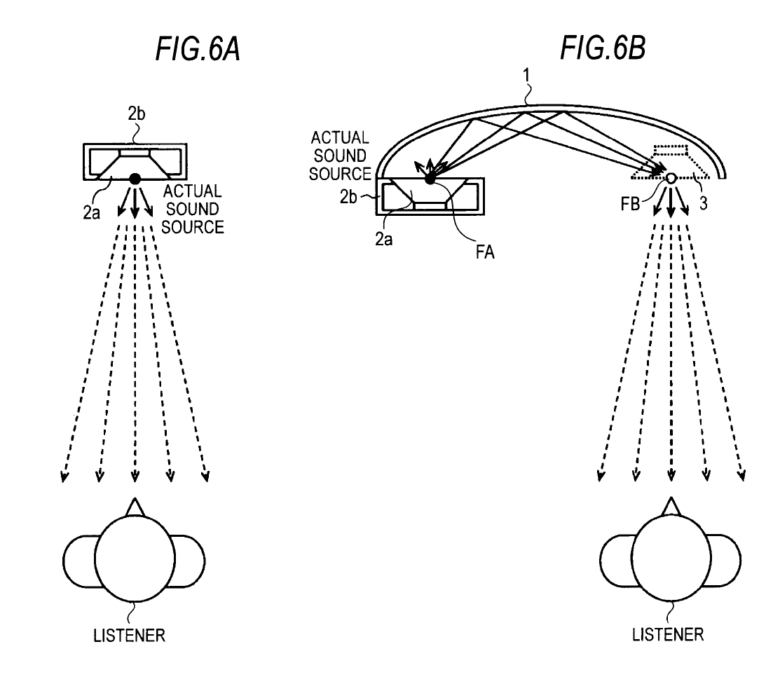

FIGS. 6A and 6B are diagrams for use in explaining a case where the loudspeaker 2a is used with the sounds-releasing surface thereof oriented toward a listener in comparison with a case where the loudspeaker assembly in accordance with the first embodiment is employed.

As shown in FIG. 6A, when the sounds-releasing surface of the loudspeaker 2a is oriented toward a listener, sounds released from the loudspeaker 2a directly reach the listener's ears.

In contrast, as shown in FIG. 6B, when the loudspeaker assembly in accordance with the first embodiment is employed, sounds released from the loudspeaker 2a are reflected from the internal wall surface of the semi-ellipsoidal body 1, concentrated on the other focus FB, and radiated to outside the semi-ellipsoidal body 1. The sounds then reach the listener's ears.

In the case of the loudspeaker assembly in accordance with the first embodiment shown in FIG. 6B, sounds radiated from the virtual sound source 3 formed at the other focus FB are identical to sounds released from the actual loudspeaker 2a in terms of the frequency characteristic, phase, and directivity.

Therefore, even when the loudspeaker assembly in accordance with the first embodiment shown in FIG. 6B is employed, sounds having nearly the same quality as sounds, which are outputted with the sounds-releasing surface of the loudspeaker 2a oriented to a listener in the same manner as that shown in FIG. 6A, can be heard.

As mentioned above, in the case of the loudspeaker assembly in accordance with the first embodiment, sounds can be radiated in a direction opposite to the sounds-releasing direction of the actual loudspeaker 2a. Therefore, the first embodiment can be adapted to various electronic equipments in which: restrictions are imposed on a position at which a loudspeaker is disposed; and the loudspeaker has to be disposed with the sounds-releasing surface thereof oriented in a direction opposite to a direction in which a listener lies.

Owing to the loudspeaker assembly in accordance with the first embodiment, even when the sounds-releasing direction of a loudspeaker is a direction opposite to the direction of a listener, sounds having the same quality as sounds released from the loudspeaker can be radiated in the direction of the listener by employing the semi-ellipsoidal body 1.

[Variants of the Loudspeaker Assembly in Accordance with the First Embodiment]

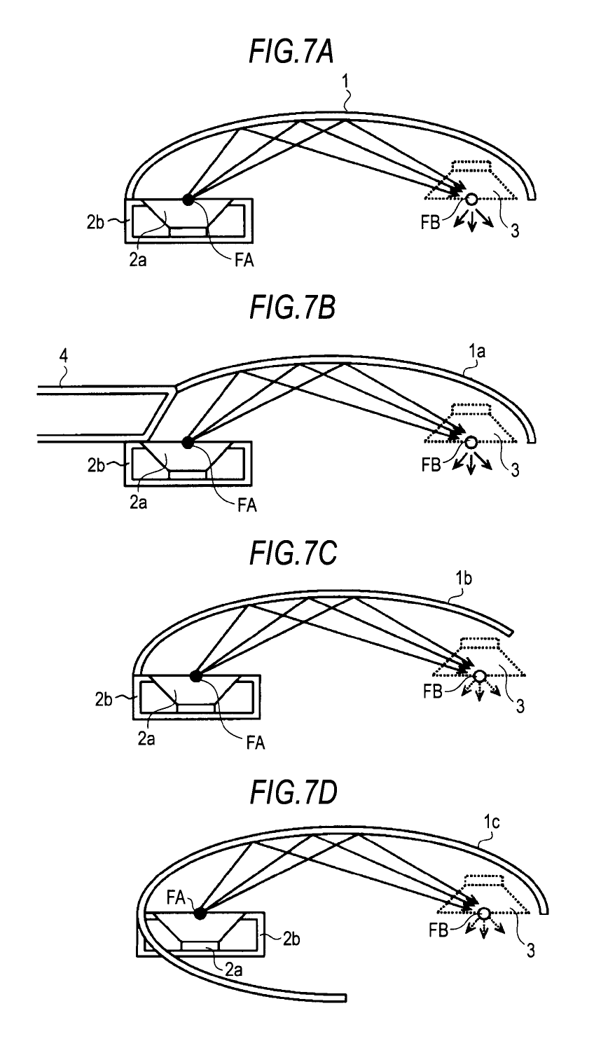

FIGS. 7A to 7D are diagrams for use in explaining variants of the loudspeaker assembly in accordance with the first embodiment. Loudspeaker assemblies shown in FIGS. 7A to 7D each include, similarly to the loudspeaker assembly in accordance with the first embodiment described in conjunction with FIG. 1A to FIG. 6B, a semi-ellipsoidal body and a loudspeaker unit, but are different from one another in terms of the shape of the semi-ellipsoidal body.

FIGS. 7A to 7D show, similarly to FIG. 4 showing the section of the loudspeaker assembly, the sections of the loudspeaker assemblies cut along the major axes of semi-ellipsoidal bodies thereof.

FIG. 7A shows the loudspeaker assembly having the same constitution as the loudspeaker assembly shown in FIG. 4. The semi-ellipsoidal body 1 has a shape obtained by bisecting an ellipsoid along a plane containing the center axis (the shape of the half of the ellipsoid). The shape shown in FIG. 7A is a standard shape of the loudspeaker assembly in accordance with the first embodiment.

However, the loudspeaker assembly in accordance with the first embodiment may be affected by the structure of an electronic equipment in which the loudspeaker assembly is incorporated. When the loudspeaker assembly is installed directly in a room or the like, the loudspeaker assembly may be affected by the state of the place of installation. Therefore, the shape of the semi-ellipsoidal body may have to be changed.

For example, as shown in FIG. 7B, when the loudspeaker assembly is affected by the housing 4 of an electronic equipment in which the loudspeaker assembly is incorporated, a semi-ellipsoidal body 1a that has the side thereof, on which the loudspeaker 2a is disposed, shortened may be adopted.

As shown in FIG. 7C, a semi-ellipsoidal body 1b having the side thereof, on which the virtual sound source 3 is formed and which is opposite to the side shown in FIG. 7B, shortened may be employed. As shown in FIG. 7D, a semi-ellipsoidal body 1c having the side thereof, on which the loudspeaker 2a is disposed, extended may be adopted.

What counts herein is that a semi-ellipsoidal body for reflecting sounds may not be an exact semi-ellipsoid. Namely, the length of the periphery of the semi-ellipsoidal body may be decreased to such an extent that a sufficient virtual sound source can be formed at the position of a focus opposite to the position of a focus at which a loudspeaker is disposed. Further, the length of the periphery of the semi-ellipsoidal body can be increased to such an extent that radiation of sounds from the virtual sound source will not be prevented.

As mentioned above, the semi-ellipsoidal body 1 may be made of various materials. For example, when a transparent material such as glass, an acrylic resin, or a polycarbonate resin is adopted, the superiority in the design can be upgraded.

### Second Embodiment

### Example in which a Loudspeaker of a Linear Sound Source is Employed

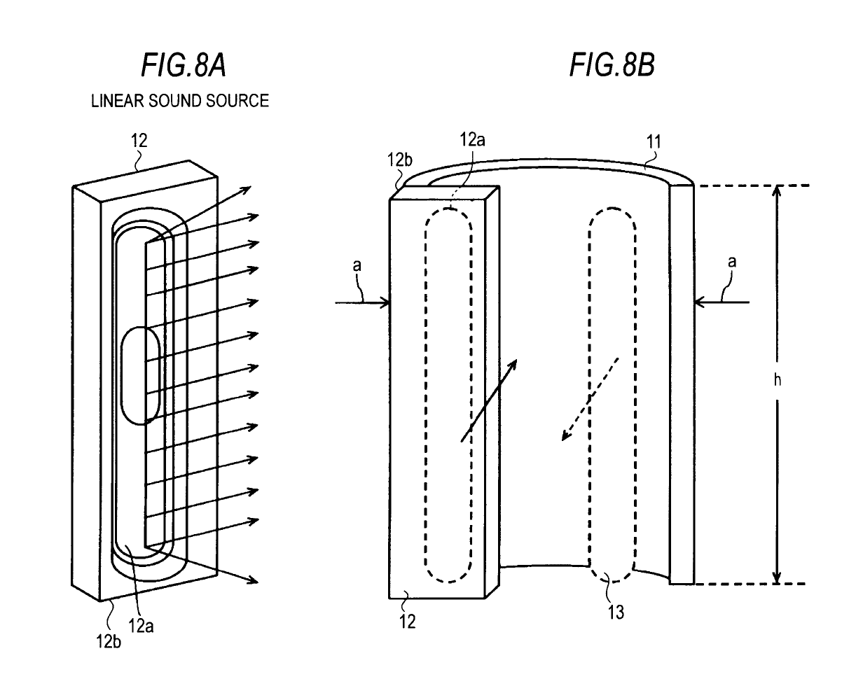

FIGS. 8A and 8B are diagrams for use in explaining a loudspeaker assembly in accordance with the second embodiment. The loudspeaker assembly in accordance with the second embodiment includes a loudspeaker 12a of a linear sound source that has, as shown in FIG. 8A, point sound sources gathered linearly in such a manner that a portion (diaphragm (cone)) thereof which outputs sounds has some length.

In the second embodiment, the loudspeaker 12a is locked in a casing 12b with the diaphragm thereof exposed to outside, whereby a loudspeaker unit 12 is constructed as shown in FIG. 8A.

Since the loudspeaker assembly in accordance with the second embodiment adopts the loudspeaker 12a of a linear sound source, a semi-ellipsoidal column 11 capable of covering the whole of the linear-sound source loudspeaker 12a is adopted as a reflector for sounds.

Specifically, the loudspeaker assembly in accordance with the second embodiment broadly includes, as shown in FIG. 8B, the semi-ellipsoidal column 11 serving as the reflector for sounds, and the loudspeaker unit 12.

The semi-ellipsoidal column 11 has, as shown in FIG. 8B, at least a height h identical to the length in a longitudinal direction of the casing 12b of the loudspeaker 12. The section of the semi-ellipsoidal column 11 cut in a direction perpendicular to the direction of the height h is semi-elliptic. The semi-ellipse is, as seen from FIG. 8B, a semi-ellipse obtained by cutting an ellipse along the major axis thereof.

Even in the loudspeaker assembly in accordance with the second embodiment, the semi-ellipsoidal column 11 is, as shown in FIG. 8B, hollowed. Namely, the semi-ellipsoidal column 11 is shaped like, for example, a gutter. The semi-ellipsoidal column 11 employed in the second embodiment is made of a material capable of reflecting sound waves, for example, a metal, a resin, a synthetic resin, wood, rubber, or glass. The semi-ellipsoidal column 11 has a thickness of, for example, about several millimeters.

Even in the case of the loudspeaker assembly in accordance with the second embodiment, the diaphragm in the loudspeaker unit 12 is opposed to the internal wall surface of the semi-ellipsoidal column 11. As shown in FIG. 8B, the loudspeaker unit 12 is fixed to the semi-ellipsoidal column 11 so that the center line of the diaphragm of the loudspeaker 12a in the longitudinal direction thereof can coincide with the position of one of the focuses existent in the direction of the height h of the semi-ellipsoidal column 11.

In the semi-ellipsoidal column 11, the other linear focus is present in the direction of the height h on the side of the semi-ellipsoidal column 11 opposite to the side thereof on which the loudspeaker unit 12 is disposed. Therefore, sounds released from the linear-sound source loudspeaker 12a are reflected from the internal wall surface of the semi-ellipsoidal column 11, and concentrated on the other focus. At the position of the other focus, a virtual sound source (sound image) is formed as a virtual sound source 13 shown in FIG. 8B.

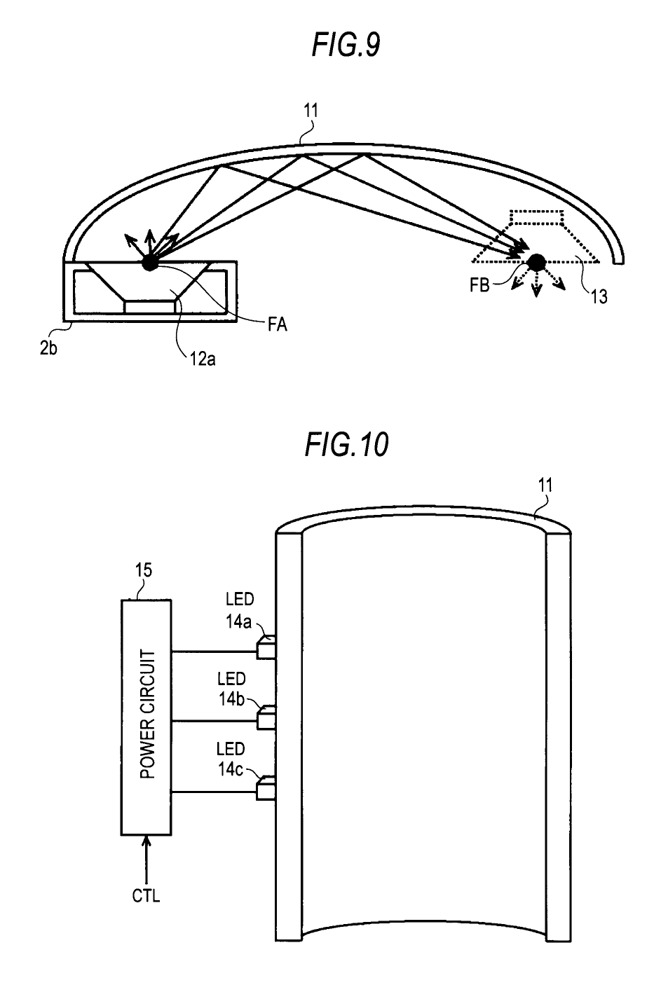

Now, the relationship between the actual sound source in the semi-ellipsoidal column 11 and the virtual sound source therein will be concretely described below. FIG. 9 shows a section of the loudspeaker assembly shown in FIG. 8B and cut along a plane indicated with an arrow a in FIG. 8B.

As shown in FIG. 9, the section of the semi-ellipsoidal column 11 constitutes a semiellipse obtained by cutting an ellipse along the major axis thereof. Therefore, similarly to the loudspeaker assembly in accordance with the first embodiment, two focuses FA and FB are present on the major axis.

Even in the loudspeaker assembly in accordance with the second embodiment, as shown in FIG. 9, the loudspeaker 12a serving as an actual sound source is disposed at the position of the focus FA in the semi-ellipsoidal column 11. Therefore, sounds released from the loudspeaker 12a are, as shown in FIG. 9, reflected from the internal wall surface of the semi-ellipsoidal column 11, concentrated on the other focus FB, and then radiated to outside the semi-ellipsoidal column 11 as indicated with arrows drawn with dot lines in FIG. 9.

As mentioned above, when the loudspeaker 12a serving as a linear sound source is adopted, the loudspeaker 12a is, as shown in FIG. 8B and FIG. 9, located at the position of one of the focuses of the semi-ellipsoidal column 11, which covers the whole of the loudspeaker 12a, so that the sounds-releasing surface thereof can be opposed to the internal wall surface of the semi-ellipsoidal column 11. Eventually, the virtual sound source is, as shown in FIG. 8B and FIG. 9, formed at the position of the other focus.

Therefore, even when the loudspeaker 12a serving as a linear sound source is employed, as long as the semi-ellipsoidal column is adopted as a reflector, sounds released from the loudspeaker 12a can be radiated in a direction opposite to the sounds-releasing direction of the loudspeaker 12a that is an actual sound source.

Therefore, even the loudspeaker assembly in accordance with the second embodiment can be adapted to various electronic equipments in which: restrictions are imposed on a position at which a loudspeaker is disposed; and the loudspeaker has to be disposed with the sounds-releasing surface thereof oriented in a direction opposite to a direction in which a listener lies.

Even in the case of the loudspeaker assembly in accordance with the second embodiment, similarly to the loudspeaker assembly in accordance with the first embodiment, although the sounds-releasing direction of the loudspeaker is opposite to the direction of a listener, sounds having the same quality as sounds released from the loudspeaker can be radiated in the direction of the listener by employing the semi-ellipsoidal column 11.

[Variants of the Loudspeaker Assembly in Accordance with the Second Embodiment]

Even in the case of the loudspeaker assembly in accordance with the second embodiment, similarly to the loudspeaker assembly in accordance with the first embodiment described in conjunction with FIGS. 7A to 7D, the length of the periphery of the semi-ellipsoidal column 11 may be set to a proper length according to the structure of a portion of an electronic equipment in which the loudspeaker assembly is incorporated.

Therefore, even in the case of the loudspeaker assembly in accordance with the second embodiment, the shape of the semi-ellipsoidal column 11 may be, similarly to the variants shown in FIGS. 7B and 7C, changed in order to shorten the periphery thereof. In addition, similarly to the variant shown in FIG. 7D, the shape of the semi-ellipsoidal column 11 may be changed to extend the periphery thereof.

Specifically, even in the case of the loudspeaker assembly in accordance with the second embodiment, the length of the periphery of the semi-ellipsoidal column may be decreased to such an extent that the sufficient virtual sound source can be formed at the position of the other focus opposite to the position of one focus at which the loudspeaker 12a is located. Further, the length of the periphery of the semi-ellipsoidal column may be increased to such an extent that radiation of sounds from the virtual sound source will not be prevented.

Further, even in the case of the loudspeaker assembly in accordance with the second embodiment, when the semi-ellipsoidal column 11 is made of a transparent material, for example, glass, an acrylic resin, or a polycarbonate resin, the superiority in the design thereof can be upgraded.

When the semi-ellipsoidal column 11 is made of a transparent material, the semi-ellipsoidal column 11 may be caused to glow by employing light-emitting elements such as light emitting diodes (LEDs). Thus, the superiority in the design can be upgraded.

FIG. 10 is a diagram for use in explaining a case where LEDs are disposed on the semi-ellipsoidal column 11. As shown in FIG. 10, LEDs 14a, 14b, and 14c are disposed on the flank of the semi-ellipsoidal column 11 on the side thereof on which the loudspeaker unit 12 is disposed.

The reason why the LEDs 14a, 14b, and 14c are mounted on the side of the semi-ellipsoidal column on which the loudspeaker 12 is disposed is that as far as the LEDs are located at the position, the LEDs are invisible to a listener.

Power is fed to the LEDs 14a, 14b, and 14c by a power circuit 15, whereby the LEDs emit light. In this case, the power circuit is controlled with a control signal CTL sent from a control unit, which is not shown, so that power corresponding to an output power level necessary for sounds to be reproduced can be fed to the LEDs 14a, 14b, and 14c.

Accordingly, the LEDs 14a, 14b, and 14c are controlled so that: when a high output power level is necessary for sounds to be reproduced, the LEDs can intensively emit light; and when a low output power level is necessary, the LEDs can feebly emit light.

Since the semi-ellipsoidal column 11 shown in FIG. 10 is made of a transparent material, when the LEDs 14a, 14b, and 14c emit light, a listener would feel that the semi-ellipsoidal column 11 emits light by itself.

The LEDs 14a, 14b, and 14c may emit light of the same color or may emit light of different colors. The number of LEDs to be mounted on the semi-ellipsoidal column is not limited to three but an arbitrary number of LEDs may be mounted.

In the case shown in FIG. 10, the LEDs are mounted on the flank of the semi-ellipsoidal column 11 on the side thereof on which the loudspeaker 12 is disposed. However, the present embodiment is not limited to this structure. Alternatively, the LEDs may be mounted on the upper or lower end of the semi-ellipsoidal column.

Even in the case of the loudspeaker assembly in accordance with the first embodiment, when the semi-ellipsoidal body 1 is made of a transparent material, light-emitting elements such as LEDs may be mounted at a proper position on the semi-ellipsoidal body 1 and caused to emit light.

### Third Embodiment

### Concrete Example of an Electronic Equipment Including the Loudspeaker Assembly

Next, as the third embodiment, a concrete example of an electronic equipment including the loudspeaker assembly in accordance with the aforesaid first or second embodiment will be described below.

### [Example of Application to a Notebook Personal Computer]

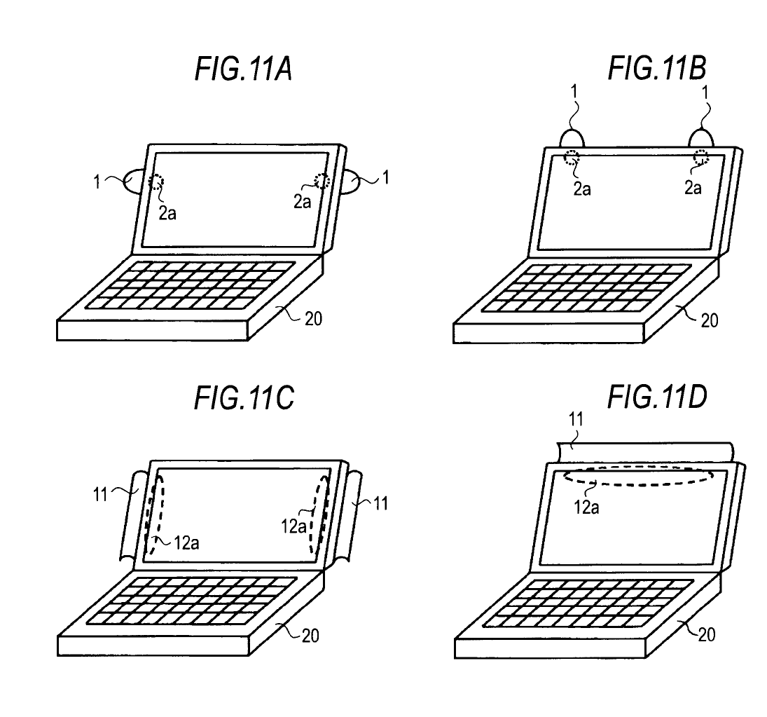

FIGS. 11A to 11D are diagrams for use in explaining a case where the loudspeaker assembly in accordance with the aforesaid first or second embodiment is incorporated in a notebook personal computer 20.

As a result of the hot pursuit of a compact, thin, and lightweight design, a position in a notebook personal computer at which a loudspeaker is located and the size of the loudspeaker, which can be incorporated in the notebook personal computer, have been strictly restricted.

As far as the notebook personal computer is concerned, when the notebook personal computer is in use, a user will not see the side of the notebook personal computer opposite to the display screen of a display. Therefore, a loudspeaker is disposed on the side of the notebook personal computer opposite to the display screen of the display, and a semi-ellipsoidal body or a semi-ellipsoidal column is integrated with the loudspeaker.

FIGS. 11A and 11B are diagrams for use in explaining a notebook personal computer to which the loudspeaker assembly in accordance with the first embodiment is adapted. In an example shown in FIG. 11A, the loudspeakers 2a serving as point sound sources are, as indicated with dot lines in FIG. 11A, disposed on the left and right respectively of the display behind the display in such a manner that the sounds-releasing surfaces thereof are oriented to the side of the notebook personal computer opposite to the display screen of the display.

In an example shown in FIG. 11B, the loudspeakers 2a serving as point sound sources are, as indicated with dot lines in FIG. 11B, disposed at the upper end of the display behind the display in such a manner that the sounds-releasing surfaces thereof are oriented to the side of the notebook personal computer opposite to the display screen of the display.

The semi-ellipsoidal body 1 is integrated with each of the loudspeakers 2a in the manner shown in FIGS. 1A and 1B. In other words, the semi-ellipsoidal body 1 is disposed so that the center of the diaphragm of the loudspeaker 2a can coincide with one of the focuses of the semi-ellipsoidal body 1.

Therefore, in the case of the notebook personal computer 20 shown in FIG. 11A or 11B, as described in conjunction with FIG. 1A to FIG. 7D, sounds released from the loudspeaker 2a are reflected from the internal wall surface of the semi-ellipsoidal body 1, concentrated on the other focus, and then radiated to outside the semi-ellipsoidal body 1.

In this case, sounds released from the loudspeaker 2a, and sounds reflected from the semi-ellipsoidal body 1 and radiated from the virtual sound source realized with the other focus are identical to each other in terms of the frequency characteristic, phase, and directivity. A user can comfortably hear the reproduced sounds.

FIGS. 11C and 11D are diagrams for use in explaining a notebook personal computer to which the loudspeaker assembly in accordance with the second embodiment is adapted. In an example shown in FIG. 11C, the loudspeakers 12a serving as linear sound sources are, as indicated with dashed lines in FIG. 11C, disposed on the left and right respectively of the display behind the display in such a manner that the sounds-releasing surfaces thereof are oriented to the side of the notebook personal computer opposite to the display screen of the display.

In an example shown in FIG. 11D, the loudspeaker 12a serving as a linear sound source is, as indicated with a dashed line in FIG. 11D, disposed at the upper end of the display behind the display in such a manner that the sounds-releasing surface thereof is oriented to the side of the notebook personal computer opposite to the display screen of the display.

The semi-ellipsoidal column 11 is integrated with each of the loudspeakers 12a in the manner shown in FIG. 8B and FIG. 9. Specifically, the semi-ellipsoidal column 11 is disposed so that the center line of the diaphragm of the loudspeaker 12a in the longitudinal direction thereof can coincide with the position of one of the focuses of the semi-ellipsoidal column 11.

Therefore, in the case of the notebook personal computer 20 shown in FIG. 11C or 11D, as described in conjunction with FIG. 8A and FIG. 9, sounds released from the loudspeaker 12a are reflected from the internal wall surface of the semi-ellipsoidal column 11, concentrated on the position of the other focus, and then radiated to outside the semi-ellipsoidal column 11.

In this case, sounds released from the loudspeaker 12a, and sounds reflected from the semi-ellipsoidal column 11 and radiated from the virtual sound source realized with the other focus are identical to each other in terms of the frequency characteristic, phase, and directivity. A user can comfortably hear the reproduced sounds.

### [Example of Application to a Television Set 1]

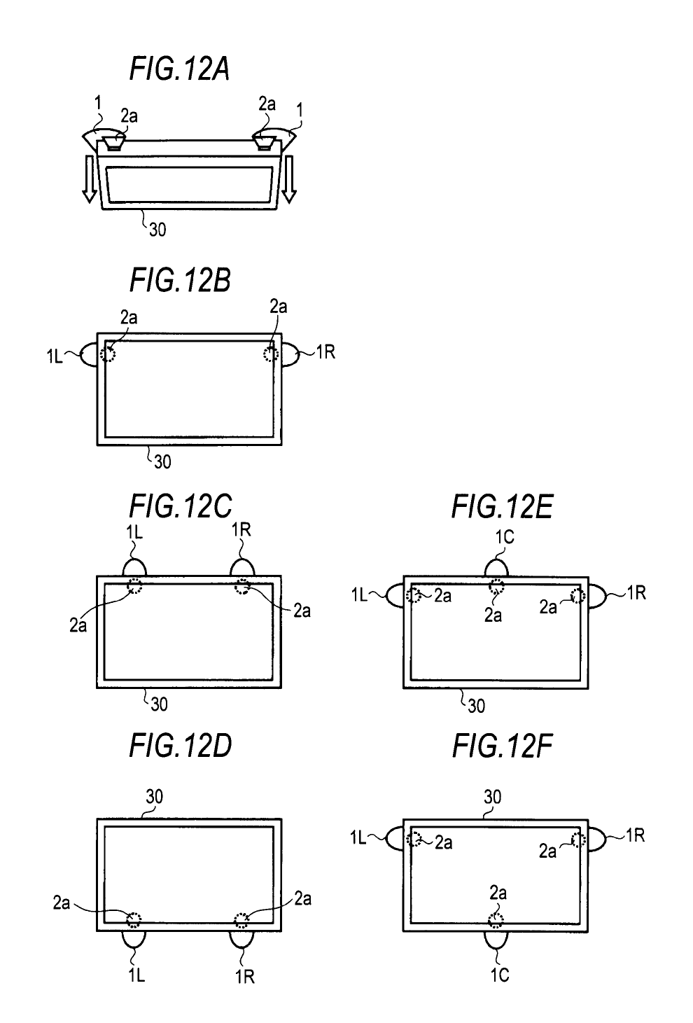

FIGS. 12A to 12F are diagrams for use in explaining a case where the loudspeaker assembly in accordance with the first embodiment is incorporated in a television set.

Even in the case of a television set, as a result of the recent pursuit of a large-screen thin design, a position at which a loudspeaker is located and the size of the loudspeaker capable of being incorporated have been strictly restricted.

Even in the case of a television set, when the television set is in use, a user will not see the side of the television set opposite to the display screen of a display. Therefore, as shown in FIG. 12A, even in the case of a television set 30, the loudspeakers 2a are disposed on the side of the television set opposite to the display screen of the display, and the semi-ellipsoidal body 1 is integrated with each of the loudspeakers 2a.

In the example shown in FIG. 12B, the loudspeakers 2a serving as point sound sources are, as indicated with dot lines in FIG. 12B, disposed on the left and right respectively of the display behind the display in such a manner that the sounds-releasing surfaces thereof are oriented to be opposite to the display screen of the display.

In the example shown in FIG. 12C, the loudspeakers 2a serving as point sound sources are, as indicated with dot lines in FIG. 12C, disposed at the upper end of the display behind the display in such a manner that the sounds-releasing surfaces thereof are oriented to be opposite to the display screen of the display.

In the example shown in FIG. 12D, the loudspeakers 2a serving as point sound sources are, as indicated with dot lines in FIG. 12D, disposed at the lower end of the display behind the display in such a manner that the sounds-releasing surface thereof are oriented to be opposite to the display screen of the display.

A semi-ellipsoidal body 1L (for a left channel) and a semi-ellipsoidal body 1R (for a right channel) are integrated with the loudspeakers 2a in the manner shown in FIGS. 1A and 1B. Specifically, the semi-ellipsoidal bodies 1L and 1R are disposed so that the center of the diaphragm of each of the loudspeakers 2a can coincide with one of the focuses of each of the semi-ellipsoidal bodies 1L and 1R.

Therefore, in the case of the television sets 30 shown in FIGS. 12B, 12C, and 12D, as described in conjunction with FIG. 1A to FIG. 7D, sounds released from each of the loudspeakers 2a are reflected from the internal surface of the semi-ellipsoidal body 1L or 1R. The reflected sounds are concentrated on the other focus, and radiated to outside the semi-ellipsoidal body 1L or 1R.

In this case, sounds released from the loudspeaker 2a, and sounds reflected from the semi-ellipsoidal body 1L or 1R and radiated from the virtual sound source realized with the other focus are identical to each other in terms of the frequency characteristic, phase, and directivity. Therefore, a user can comfortably hear the reproduced sounds.

For reproduction of sounds in a so-called surround sound mode, as shown in FIG. 12E, the loudspeakers 2a serving as point sound sources are, as indicated with dot lines in FIG. 12E, disposed on the left and right respectively of the display and at the upper end of the display behind the display in such a manner that the sounds-releasing surfaces thereof are oriented to be opposite to the display screen of the display.

In this case, the loudspeaker disposed on the left of the display reproduces sounds routed to the left channel, and the loudspeaker disposed on the right of the display reproduces sounds routed to the right channel. Further, the loudspeaker disposed at the upper end of the display reproduces sounds routed to the center channel.

Even in this case, the semi-ellipsoidal body 1L (for the left channel), the semi-ellipsoidal body 1R (for the right channel), and a semi-ellipsoidal body 10 (for the center channel) are integrated with the respective loudspeakers 2a. Specifically, the semi-ellipsoidal bodies 1L, 1R, and 10 are disposed so that the center of the diaphragm of each of the loudspeakers 2a can coincide with one of the focuses of the semi-ellipsoidal body 1L, 1R, or 10.

Therefore, even in the case where sounds are reproduced in the so-called surround sound mode, sounds to be routed to the left channel, right channel, and center channel that are primarily employed can be reproduced using the loudspeaker assembly in which the present invention is implemented.

As for a loudspeaker for a rear channel, a separately included loudspeaker may be installed behind a listener. A subwoofer loudspeaker may also be separately included. The subwoofer loudspeaker may be located at a proper position in the television set 30 by adopting the loudspeaker assembly in which the present invention is implemented.

The center-channel loudspeaker may be, as shown in FIG. 12F, disposed in the lower-end part of the television set 30. In FIGS. 12E and 12F, the positions of the loudspeakers on the left and right respectively of the display are positions at the upper end of the display, but the invention is not limited to this. Alternatively, the loudspeakers may be disposed in the centers on the left and right respectively of the display or disposed on the left and right respectively of the display at the lower end of the display.

### [Example of Application to a Television Set 2]

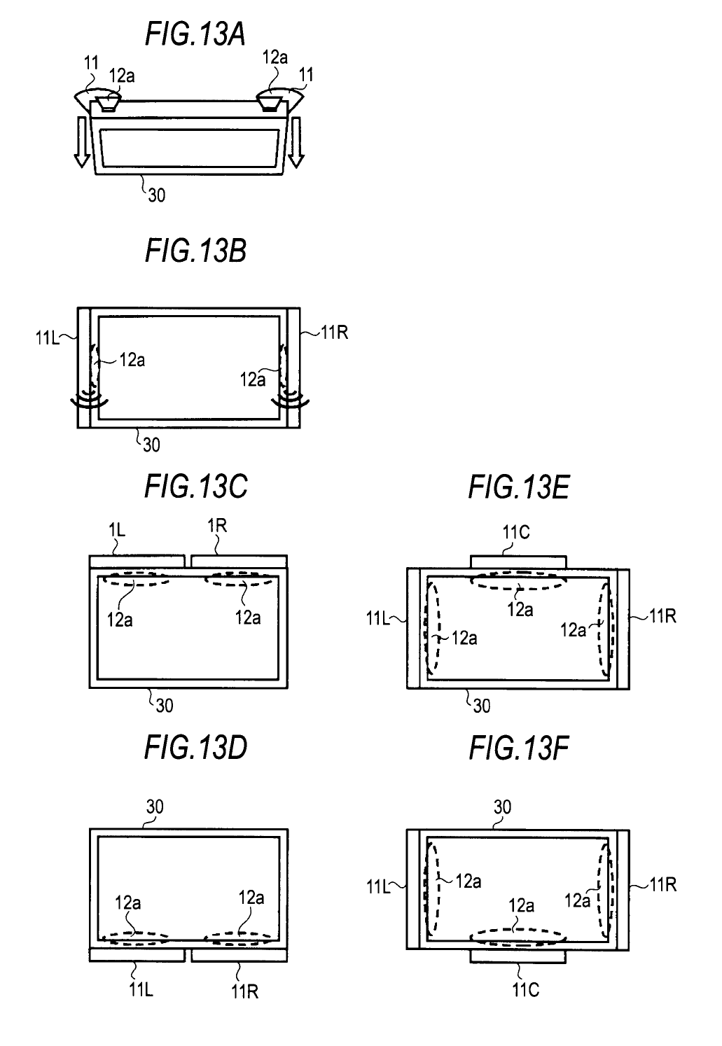

FIGS. 13A to 13F are diagrams for use in explaining a case where the loudspeaker assembly in accordance with the second embodiment is incorporated in a television set.

Even in this case, as shown in FIG. 13A, the loudspeakers 12a are disposed on the side of the television set 30 opposite to the display screen of the display. The semi-ellipsoidal column 11 is integrated with each of the loudspeakers 12a.

In an example shown in FIG. 13B, the loudspeakers 12a serving as linear sound sources are, as indicated with dashed lines in FIG. 13B, disposed on the left and right respectively of the display behind the display in such a manner that the sounds-releasing surfaces thereof are oriented to be opposite to the display screen of the display.

In an example shown in FIG. 13C, the loudspeakers 12a serving as linear sound sources are, as indicated with dashed lines in FIG. 13C, disposed at the upper end of the display behind the display in such a manner that the sounds-releasing surfaces thereof are oriented to be opposite to the display screen of the display.

In an example shown in FIG. 13D, the loudspeakers 12a serving as linear sound sources are, as indicated with dashed lines in FIG. 13D, disposed at the lower end of the display behind the display in such a manner that the sounds-releasing surfaces thereof are oriented to be opposite to the display screen of the display.

The semi-ellipsoidal column 11L (for the left channel) and semi-ellipsoidal column 11R (for the right channel) are integrated with the respective loudspeakers 12a in the manner shown in FIG. 8B and FIG. 9. In other words, the semi-ellipsoidal columns 11L and 11R are disposed so that the center line of the diaphragm of each of the loudspeakers 12a in the longitudinal direction thereof can coincide with the position of one of the focuses of the semi-ellipsoidal column 11L or 11R.

Therefore, in the case of the television sets 30 shown in FIGS. 13B, 13C, and 13D, as described in conjunction with FIG. 8B and FIG. 9, sounds released from the loudspeaker 12a are reflected from the internal wall surface of the semi-ellipsoidal column 11L or 11R. The reflected sounds are concentrated on the position of the other focus, and then radiated to outside the semi-ellipsoidal column 11L or 11R.

In this case, sounds released from the loudspeaker 12a, and sounds reflected from the semi-ellipsoidal column 11L or 11R and radiated from the virtual sound source realized with the other focus are identical to each other in terms of the frequency characteristic, phase, and directivity. Accordingly, a user can comfortably hear the reproduced sounds.

For reproduction of sounds in a so-called surround sound mode, as shown in FIG. 13E, the loudspeakers 12a serving as linear sounds sources are, as indicated with dashed lines in FIG. 13E, disposed on the left and right of the display and at the upper end of the display behind the display in such a manner that the sounds-releasing surfaces thereof are oriented to be opposite to the display screen of the display.

In this case, the loudspeaker disposed on the left of the display reproduces sounds routed to the left channel, and the loudspeaker disposed on the right of the display reproduces sounds routed to the right channel. Further, the loudspeaker disposed at the upper end of the display reproduces sounds routed to the center channel.

Even in this case, the semi-ellipsoidal columns 11L (for the left channel), 11R (for the right channel), and 11C (for the center channel) are integrated with the respective loudspeakers 12a in the manner shown in FIG. 8B and FIG. 9.

Specifically, the semi-ellipsoidal column 11 is integrated with each of the loudspeakers 12a so that the center line of the diaphragm of each of the loudspeakers 12a in the longitudinal direction thereof can coincide with the position of one of the focuses of the semi-ellipsoidal column 11L, 11R, or 11C.

Therefore, even when sounds are reproduced in the so-called surround sound mode, sounds routed to the left channel, right channel, and center channel that are primarily employed can be reproduced using the loudspeaker assemblies in which the present invention is implemented.

Even in this example, as a loudspeaker for the rear channel, a separately included loudspeaker may be installed behind a listener. A subwoofer loudspeaker may also be separately included. As the subwoofer loudspeaker, the loudspeaker assembly in which the present invention is implemented may be disposed at a proper position in the television set 30.

Further, the center-channel loudspeaker may be, as shown in FIG. 13F, disposed in the lower-end part of the television set 30.

[Movable Semi-Ellipsoidal Column or Semi-Ellipsoidal Body]

In the case of the electronic equipments described in conjunction with FIG. 11A to FIG. 13F, the semi-ellipsoidal bodies 1 or semi-ellipsoidal columns 11 have been described to be immovable. Namely, the semi-ellipsoidal bodies 1 or semi-ellipsoidal columns 11 are used while being projected from the housing of each of the electronic equipments.

However, when the loudspeaker is unused or the electronic equipment is moved, the semi-ellipsoidal body 1 or semi-ellipsoidal column 11 projected from the housing of the electronic equipment may become an obstacle.

When the semi-ellipsoidal body 1 or semi-ellipsoidal column 11 is made movable, if a loudspeaker is unused or an electronic equipment is moved, the semi-ellipsoidal body 1 or semi-ellipsoidal column 11 can be stored in the housing of the electronic equipment.

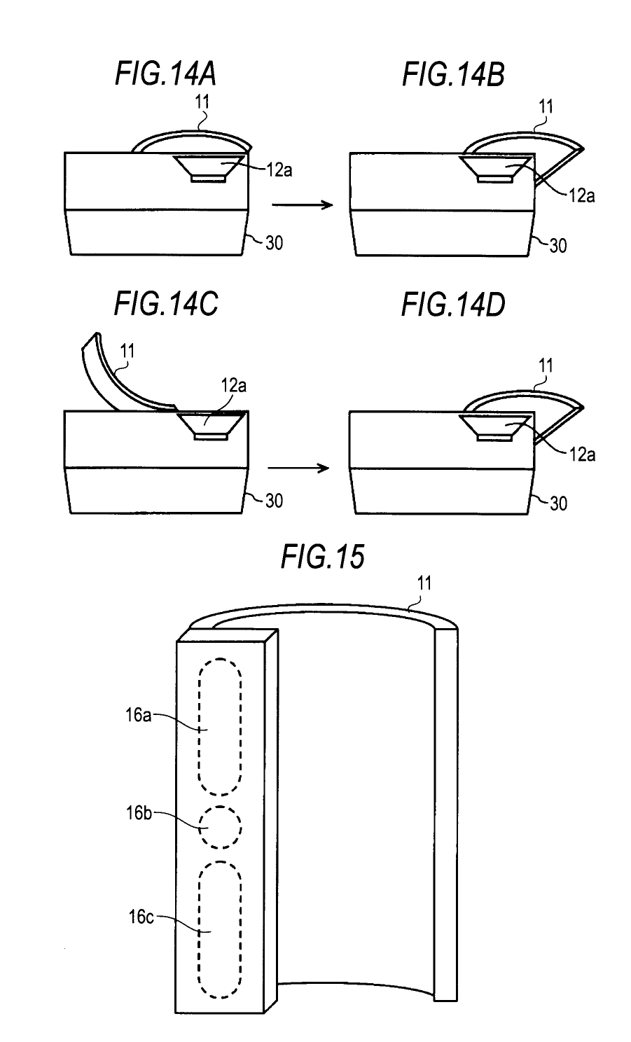

FIGS. 14A to 14D are diagrams for use in explaining a case where the semi-ellipsoidal column 11 is disposed to be movable with respect to an electronic equipment (for example, a television set 30). Among FIGS. 14A to 14D, FIGS. 14A and 14B are diagrams for use in explaining the semi-ellipsoidal column 11 that is movable like a so-called sliding door, and FIGS. 14C and 14D are diagrams for use in explaining the semi-ellipsoidal column 11 that is movable like a hinged door.

FIG. 14A shows a state in which the sliding door type semi-ellipsoidal column 11 is stored in the housing of the television set 30. FIG. 14B shows a state in which the semi-ellipsoidal column 11 is pulled out to be projected from the housing of the television set 30.

FIG. 14C shows a state in which the hinged door type semi-ellipsoidal column 11 is stored in the housing of the television set 30. FIG. 14D shows a state in which the semi-ellipsoidal column 11 is closed to be projected from the housing of the television set 30.

As mentioned above, the semi-ellipsoidal column 11 is attached to be movable with respect to the housing of an electronic equipment. Therefore, only when the loudspeaker is used, the semi-ellipsoidal column 11 can be enabled to project from the housing of the electronic equipment.

Herein, a description has been made of a case where the semi-ellipsoidal column 11 is made movable. Similarly, the semi-ellipsoidal body 1 can be attached to the housing of an electronic equipment to be movable like a sliding door or like a hinged door.

In addition, the semi-ellipsoidal body 1 or semi-ellipsoidal column 11 can be made attachable or detachable to or from the housing of an electronic equipment. In this case, for example, when the electronic equipment is moved, the semi-ellipsoidal body 1 or semi-ellipsoidal column 11 is detached from the housing of the electronic equipment for fear the semi-ellipsoidal body 1 or semi-ellipsoidal column 11 may interfere with the movement.

### [Coexistence of a Point Sound Source and Linear Sound Sources]

In relation to the aforesaid embodiments, the loudspeaker assembly employing the loudspeaker 2a of a point sound source and the loudspeaker assembly employing the loudspeaker 12a of a linear sound source have been described. However, the present invention is not limited to the loudspeaker assemblies. Both the loudspeaker of a point sound source and the loudspeakers of linear sound sources may be employed.

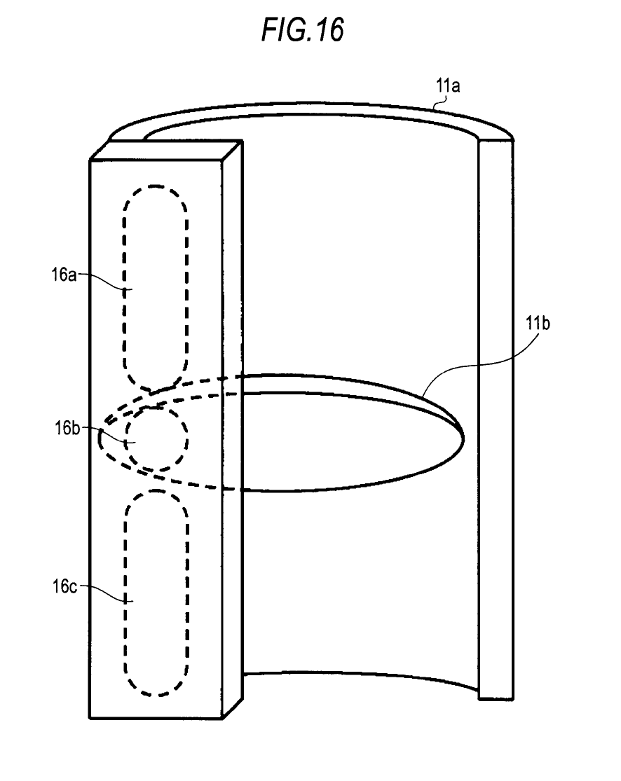

FIG. 15 and FIG. 16 are diagrams for use in explaining examples of the constitution of a loudspeaker assembly employing both a loudspeaker of a point sound source and loudspeakers of linear sound sources. The first example basically includes, as shown in FIG. 15, similarly to the loudspeaker assembly shown in FIG. 8B, a loudspeaker unit and the semi-ellipsoidal column 11.

However, as shown in FIG. 15, the loudspeaker unit includes loudspeakers 16a and 16c of linear sounds sources and a loudspeaker 16b of a point sound source. The linear-sound source loudspeakers 16a and 16c are used to reproduce sounds of middle pitches or bass, and the point-sound source loudspeaker 16b is used to reproduce sounds of high pitches. Thus, the loudspeakers are used for the different musical ranges of pitches.

As mentioned above, ideally, released sounds are reflected from the internal wall of a semi-ellipsoidal body in order to form a virtual sound source of a point-sound source loudspeaker that employs elliptic reflection. In the second example, a loudspeaker assembly including both a loudspeaker of a point sound source and loudspeakers of linear sound sources employs, as shown in FIG. 16, a reflecting wall having a semi-ellipsoidal column 11a and a semi-ellipsoidal body 11b combined.

The constitution shown in FIG. 16 is ideal for forming a sound source from which the same sounds as sounds released from an actual loudspeaker can be radiated. In this case, the semi-ellipsoidal column 11a and semi-ellipsoidal body 11b may be separately constructed and then combined. The semi-ellipsoidal column 11a and semi-ellipsoidal body 11b may be formed as a united body.

### Fourth Embodiment

### Concrete Example of a Portable Cellular Phone in which a Loudspeaker Assembly is Incorporated

Next, as the fourth embodiment, a concrete example of a portable cellular phone in which the loudspeaker assembly in accordance with the first embodiment is incorporated will be described below.

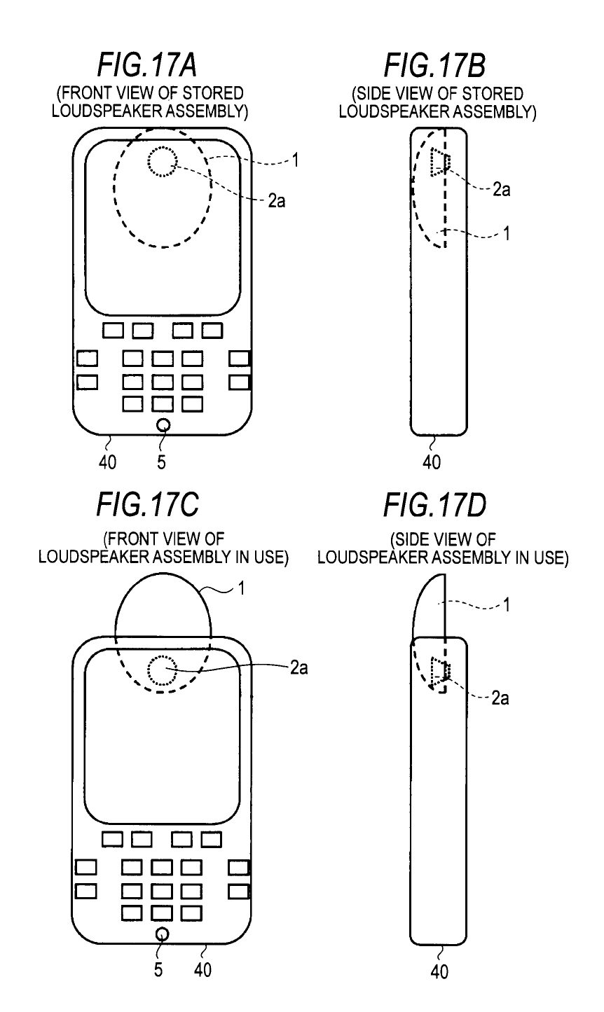

FIGS. 17A to 17D are diagrams for use in explaining a case where the loudspeaker assembly in accordance with the first embodiment is incorporated in a portable cellular phone.

Portable cellular phones have been encouraged to be compact, thin, and lightweight. It has become a matter of common practice to adopt a display device having a relatively large display screen. As a result, the position in a portable cellular phone at which a loudspeaker serving as a telephone receiver is located, and the size of the loudspeaker capable of being incorporated are strictly restricted.

In the fourth embodiment, a loudspeaker is disposed on the side of a portable cellular phone opposite to the display screen of a display, and a semi-ellipsoidal body or a semi-ellipsoidal column is integrated with the loudspeaker.

In a portable cellular phone 40 in accordance with the fourth embodiment, a point-sound source loudspeaker 2a is, as indicated with a dot line in FIGS. 17A to 17D, disposed in the upper-end part of the inside of the housing of the portable cellular phone 40 in such a manner that the sounds-releasing surface thereof is oriented in a direction opposite to the display screen of the display.

The semi-ellipsoidal body 1 serving as a reflecting plate for sounds is integrated with the loudspeaker 2a. When the portable cellular phone 40 is not used as a telephone terminal, the semi-ellipsoidal body 1 is, as indicated with a dashed line in FIGS. 17A and 17B, stored in the housing of the portable cellular phone 40.

When the portable cellular phone 40 is not used as a telephone terminal (speech is not made on the portable cellular phone), the semi-ellipsoidal body 1 is not projected to outside the housing of the portable cellular phone 40. The semi-ellipsoidal body 1 will therefore not become an obstacle.

When a call is originated or a call is terminated, the semi-ellipsoidal body 1 stored in the housing of the portable cellular phone 40 is, as shown in FIGS. 17C and 17D, pulled out of the housing of the portable cellular phone 40.

As shown in FIGS. 17C and 17D, when the semi-ellipsoidal body 1 is pulled out of the housing of the portable cellular phone 40, the center of the diaphragm of the built-in loudspeaker 2a coincides with one of the focuses of the semi-ellipsoidal body 1.

Therefore, although the loudspeaker 2a is stored in the housing of the portable cellular phone 40, sounds released from the loudspeaker 2a are heard as if they were radiated from the position of the other focus of the semi-ellipsoidal body 1 that is pulled out to be projected from the housing.

Specifically, sounds released from the loudspeaker 2a are reflected from the internal wall surface of the semi-ellipsoidal body 1, concentrated on the other focus, and radiated to outside the semi-ellipsoidal body 1. Therefore, the sounds released from the loudspeaker 2a stored in the housing of the portable cellular phone 40 can be comfortably heard.

Therefore, since it is unnecessary to make the sounds-releasing surface of the loudspeaker, which serves as a telephone receiver, flush with the surface of the portable cellular phone 40, the position at which the loudspeaker is located can be determined flexibly.

The loudspeaker assembly has been described so far. The loudspeaker assembly has nearly the same constitution as a microphone does. Therefore, the present invention may be applied to the microphone.

Specifically, the semi-ellipsoidal body is disposed to be able to be, similarly to the semi-ellipsoidal body 1 integrated with the loudspeaker 2a, projected from the lower part of the housing of the portable cellular phone 40. A microphone is disposed in the lower part of the housing of the portable cellular phone 40. In this case, the microphone is located at a position coinciding with one of the focuses of the semi-ellipsoidal body 1 projected from the lower part of the housing of the portable cellular phone 40.

When speech is made, voice uttered from a user's mouth is radiated to the other focus of the semi-ellipsoidal body 1 projected from the lower part of the housing of the portable cellular phone 40. In this case, the user's talking voice uttered to the other focus of the semi-ellipsoidal body 1 is reflected from the internal wall surface of the semi-ellipsoidal body 1, and concentrated on one of the focuses, that is, the focus at which the microphone is positioned.

Thus, even when the microphone serving as a telephone transmitter does not have the voice-collecting surface thereof exposed to outside the housing of the portable cellular phone 40, user's talking voice can be collected to the built-in microphone.

As mentioned above, the loudspeaker assembly in accordance with the first embodiment can be adapted to the portable cellular phone. The present invention can be applied as a microphone assembly employing a microphone that has the same constitution as a loudspeaker does.

Even the electronic equipments shown in FIG. 11A to FIG. 14D and FIGS. 17A to 17D the semi-ellipsoidal body 1 or semi-ellipsoidal column 11 may be made of a transparent material, for example, glass, an acrylic resin, or a polycarbonate resin, whereby the superiority in the design can be upgraded.

### ADVANTAGE OF THE EMBODIMENTS

Since a virtual sound source is formed by utilizing reflection of sounds by a reflector providing an elliptic curved surface, even when a loudspeaker is located at a position at which the loudspeaker is invisible to a listener, a loudspeaker assembly capable of reproducing high-quality sounds can be realized.

When the reflector is made of a transparent material, a transparent loudspeaker which is not recognized as a loudspeaker by a listener can be realized.

### [Miscellaneous]

In the aforesaid embodiments, the loudspeaker 2a serving as a point sound source is stored in the casing 2b, and the loudspeaker 12a serving as a linear sound source is stored in the casing 12b. Thus, sounds released from the rear side of the loudspeaker 2a or 12a are not leaked out.

The present invention is not limited to the foregoing structure. As long as the loudspeaker 2a or 12a can be disposed, the rear space of the loudspeaker may be left open in order to radiate sounds, which are released from the rear side of the loudspeaker 2a or 12a, to outside.

The sounds radiated from behind the loudspeaker 2a or 12a can be provided for a listener. An unprecedented sound field can be reproduced.

When the internal wall surface of the semi-ellipsoidal body 1 or semi-ellipsoidal column 11 is finished as a mirrored surface, the superiority in the design can be upgraded.

When fiber such as felt or cloth is bonded to the internal wall surface of the semi-ellipsoidal body 1 or semi-ellipsoidal column 11, sounds of high pitches can be absorbed to some extent. Thus, the frequency characteristic can be slightly modified.

As described in conjunction with FIG. 10, when light-emitting elements such as LEDs are employed, if a flaw or pattern is inscribed in the internal wall surface of the semi-ellipsoidal body 1 or semi-ellipsoidal column 11, an effect of concentrating light, which emanate from the light-emitting elements, on the flow or pattern can be exerted.

In relation to the aforesaid embodiments, the cases where the present invention is applied to a notebook personal computer, a television set, or a portable cellular phone have been described. Electronic equipments to which the present invention can be applied are not limited to the notebook personal computer, television set, and portable cellular phone.

The loudspeaker assembly in which the present invention is implemented can be adapted to various electronic equipments, which reproduce an audio signal and radiate sounds, for example, a game machine and various music reproduction equipments.

The present application contains subject matter related to that disclosed in Japanese Priority Patent Application JP 2009-115144 filed in the Japan Patent Office on May 12, 2009, the entire contents of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A loudspeaker assembly comprising a loudspeaker located at the position of one of the focuses of a reflector, whose over-internal wall section constitutes a part of an ellipse, in such a manner that the sounds-releasing surface of the loudspeaker is oriented to be opposite to the internal wall surface of the reflector.

2. The loudspeaker assembly according to claim 1, wherein the reflector constitutes a part of an ellipsoidal body, and the loudspeaker serves as a point sound source.

3. The loudspeaker assembly according to claim 1, wherein the reflector constitutes a part of an ellipsoidal column, and the loudspeaker serves as a linear sound source.

4. The loudspeaker assembly according to claim 1, wherein the reflector is made of a transparent material.

5. An electronic equipment comprising a loudspeaker assembly, which has a loudspeaker located at the position of one of the focuses of a reflector, whose over-internal wall section constitutes a part of an ellipse, with the sounds-releasing surface of the loudspeaker oriented to be opposite to the internal wall surface of the reflector, is incorporated in such a manner that the position of the other focus of the reflector is projected from the housing of the electronic equipment.

6. The electronic equipment according to claim 5, wherein the reflector constitutes a part of an ellipsoidal body, and the loudspeaker serves as a point sound source.

7. The electronic equipment according to claim 5, wherein the reflector constitutes a part of an ellipsoidal column, and the loudspeaker serves as a linear sound source.

8. The electronic equipment according to claim 5, wherein the reflector is made of a transparent material.

9. The electronic equipment according to claim 5, wherein the loudspeaker assembly can be stored in the housing of the electronic equipment.
